(19) United States
(12) Patent Application Publication
(10) Pub. No.: US 2010/0271962 A1
(43) Pub. Date: Oct. 28, 2010

(54) AVAILABLE BACKHAUL BANDWIDTH ESTIMATION IN A FEMTO-CELL COMMUNICATION NETWORK

(75) Inventors: Guang Han, Arlington Heights, IL (US); Rajeev Agrawal, Northbrook, IL (US); Anand S. Bedekar, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/427,777

(22) Filed: Apr. 22, 2009

(51) Int. Cl. H04L 12/26

(52) U.S. Cl. 370/252

(57) ABSTRACT

A method and apparatus for estimating an available backhaul bandwidth in a femto-cell communication network includes a step (204, 304) of sending at least one defined data stream to at least one femto-cell. A next step (206, 306) includes measuring a delay of the at least one defined data stream at the at least one femto-cell. A next step (208, 308) includes estimating, from the delay of the at least one defined data stream, a backhaul bandwidth availability.

### FIELD OF THE INVENTION

This invention relates to communication networks, and in particular, to a mechanism for estimating an available backhaul bandwidth capability in a femto-cell communication network.

### BACKGROUND OF THE INVENTION

Upcoming wireless Fourth Generation (4G) communication systems, such as Long Term Evolution (LTE), Worldwide Interoperability for Microwave Access (WiMAX), and Ultra Mobile Broadband (UMB), will offer end-users higher and higher communication bandwidth. These systems are also being designed with a communication hierarchy consisting of larger macro-cell coverage, and smaller micro-cell, pico-cell, or femto-cell coverage underlaying the macro-cell. As used herein, the term femto-cell will be used for any cell underlaying a macro-cell, such as a micro-cell, pico-cell, or femto-cell. End-users in these systems will be able to subscribe to high bit rate service plans offering communication rates from 1 Mbps to 100 Mbps, with the highest available Quality of Service (QoS). To support these rates, communication networks are being designed with appropriate backhaul and transport systems.

Typically, a femto-cell is operable within a user's home environment, and will use a wired Digital Subscriber Line (DSL) or cable Internet Service Provider (ISP) connection as the backhaul connection. This ISP connection may have a lower bandwidth than is available through the over-the-air capacity of the wireless 4G connection, and a user equipment may then experience a reduction in service. As a result, when subscribers in the macro-cell wireless communication environment move to a home femto-cell coverage area, they may experience limited backhaul bandwidth and QoS depending on the available bandwidth of the ISP connections with the femto-cells.

In addition, a further problem arises in that the 4G wireless communication system operator will continue to support and use subscribed service plans to reserve appropriate macro-cell bandwidth with no understanding for ISP backhaul limitations for home femto-cells. This will result in macro-cell bandwidth/QoS allocations being under utilized since the subscriber is now using a limited ISP connection, and also result in decreased capacity due the reserved but unused bandwidth/QoS, when the wireless communication system is capable of supporting more users and wireless bandwidth. Without an estimation of an available backhaul bandwidth, a femto-cell can not make proper decisions on scheduling, admission control, or load balancing.

Thus, there exists a need in the field of the present invention to estimate a backhaul capability of femto-cells.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows an overview block diagram of a 4G communication system, in accordance with the present invention;

FIG. 2 is a flow chart illustrating a method, in accordance with an uplink embodiment of the present invention; and

FIG. 3 is a flow chart illustrating a method, in accordance with a downlink embodiment of the present invention.

Skilled artisans will appreciate that common but well-understood elements that are useful or necessary in a commercially feasible embodiment are typically not depicted or described in order to facilitate a less obstructed view of these various embodiments of the present invention.

### DESCRIPTION OF THE PREFERRED EMBODIMENTS

The present invention provides a framework to determine a backhaul capability of femto-cells. This information can be used in the management of femto-cells. In particular, with an estimation of an available backhaul bandwidth, a femto-cell can make proper decisions on scheduling, admission control, or load balancing. As described herein, a femto-cell base station, home base station, home Node B (HNB), home enhanced NodeB (H(e)NB), and femto-cell access point all refer to the same entity. In addition, the term “bandwidth” is equivalent with the terms “throughput” or “capacity” as are used herein.

The following description focuses on embodiments of the invention applicable to 4G and LTE communication systems. However, it will be appreciated that the invention is not limited to this application but may be applied to many other cellular communication systems such as a 3rd generation (3G) cellular communication systems based on Code Division Multiple Access (CDMA) technology, such as the Universal Mobile Telecommunication System (UMTS) and High-Speed Packet Access (HSPA), for example. Also, the description will focus on scenarios of a serving gateway of one or more femto-cell access points. However, it will be appreciated that the principles described herein could be apply equally well to other communication scenarios.

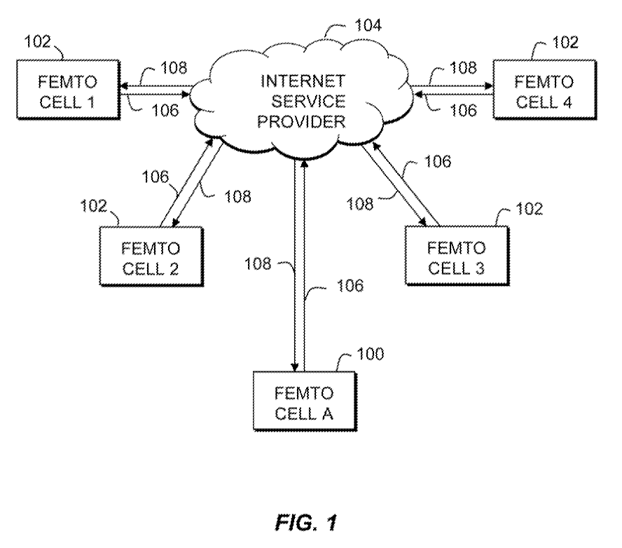

FIG. 1 illustrates an example of a 4G communication system which in the specific example is a LTE communication system implementing femto-cells 100, 102 connected through a home ISP connection. In the system, a macro-layer is formed by macro-cells supported by base stations (not shown). Furthermore, an underlay layer of pico-cells or femto-cells 100, 102 are supported by a home base stations which can also be referred to as access points. Specifically, each access point may have an intended coverage of a single house or dwelling, or even individual rooms. It should be recognized that there are several other network entities, such as routers, switches, a DSL Access Multiplexer, a femto network gateway, a radio network controller, and the like, that are not shown for the sake of simplicity.

In the specific example of FIG. 1, receiving femto-cell A access point (AP) 100 is illustrated, which supports a femto-cell within a dwelling for example. The AP 100 is coupled to other femto-cells 102 via a backhaul internet connection through an internet service provider 104, which may includes a DSL Access Multiplexer. These other femto-cells 102 may be located in the same dwelling as femto-cell A 100 or can be located far away from femto-cell A. Each femto-cell 100, 102 includes a transceiver under control of a processor, as is known in the art. Any user equipment in the dwelling will be using an Internet Service Provider (ISP) connection as a backhaul connection from its serving femto-cell A 100 to other femto-cells 102 or to an associated femto network gateway. The femto-cell 100 will support the user equipment using the available wireless bandwidth, but with no understanding for ISP backhaul limitations of the ISP 104.

In order to remedy this situation, the present invention determines a communication capability of a backhaul ISP connection 106 for the femto-cell 102 for either an uplink 106 and/or a downlink 108. The determination of the communication capability of the backhaul ISP connection can include channel bandwidth, desired bit rate, frequency plan, assigned resource blocks, a desired transmit power per channel, etc.

Once the communication capability of the ISP backhaul connection is determined, the femto-cell 100 can be configured to use appropriate communication resources, i.e. channel bandwidth, allocated bandwidth, allocated Quality of Service (QoS) etc. with respect to the ISP backhaul connection limitations. In other words, the femto-cell 100 can direct a served user equipment that it is limited to use resources no greater than that available from the femto-cell ISP connection.

When the femto-cell 100 estimates that there are any bandwidth limitations, the femto-cell 100 could then take action to adjust transmission, such as removing bandwidth, determining which applications can (e.g. text message) or cannot (e.g. Voice over IP) be used by the ISP depending, changing Quality of Service (QoS) for user equipment, etc.

In a downlink embodiment, the present invention provides an estimation of an available backhaul downlink bandwidth in a femto-cell communication network. Femto-cell A 100 includes a transceiver and a processor coupled to the transceiver. In this embodiment, the femto-cell processor is operable to send a message through the transceiver requesting at least one other femto-cell to send a defined data stream 108 to the femto-cell 100. Every data stream is a stream of equally spaced packets sent at a defined rate. In the example shown, the femto-cell 100 requests four other femto-cells 102 to each send it the data stream 108. In this event the femto-cell transceiver receives a sum rate of four data streams 108. If none of the data streams 108 is received at a constant rate by the femto cell 100, this indicates that there is a downlink bandwidth limitation that is delaying the reception of the data streams by the femto-cell 100, and the femto cell 100 will send acknowledgements to the sending femto cells 102 to terminate their transmissions In particular, the processor is operable to measure delays of consecutive packets of each of these four defined data streams, and estimate, from such delays of the at least one defined data stream, a downlink backhaul bandwidth availability. Specifically, if the delays of each data stream remain constant then the processor determines that the rate of the summed data streams is smaller than the available downlink backhaul bandwidth Otherwise, if the delays of any one of the four one data stream starts increasing then the processor determines that the sum rate of the four data streams is larger than the available downlink backhaul bandwidth, whereupon the processor can adjust data transmissions to meet the downlink bandwidth availability.

In an uplink embodiment, the present invention provides an estimation of an available backhaul uplink bandwidth in a femto-cell communication network. Femto-cell A 100 includes a transceiver and a processor coupled to the transceiver. In this embodiment, the femto-cell 100 processor can direct the transceiver to send a defined data stream to every other femto-cell 102 on the femto-cell 100 uplink. The sum of the rates of all the probing data streams is determined by air interface requirements. Every defined (probing) data stream is a stream of equally spaced packets sent at a defined rate. The defined rate can be chosen based on radio operating parameters. The IP addresses of the other femto-cells 102 can be provided by a femto-cell management system, so that a femto-cell gateway or other network entity need not get involved to impart the advantage provided by the present invention. It should be noted that the routes 106 from the sending femto-cell 100 towards the other receiving femto-cells 102 will not be the same. After a DSL Access Multiplexer, the packet streams towards the other femto-cells 102 may pass through completely different routers/switches. Preferably, a femto-cell management system (or the sending femto-cell 102 itself) can pick target femto-cells that are far apart from each other to reduce the traffic correlation among different routes.

Each of the other femto-cells 102 measures the delays of the received packets of the defined data stream 106 in its backhaul downlink. If the delays of the stream remain constant, each other femto-cell 102 determines that the rate of the data stream is smaller than the end-to-end available bandwidth, and reports this result to the sender. If the delays of the packet stream increase as the other femto-cell 102 is receiving the stream 106, the other femto-cell 102 determines that the rate of the packet stream is larger than the end-to-end available bandwidth, and reports this result to the sender. The femto-cell 100 processor then receives these individual reports from each other femto-cell 102 detailing that other femto-cell's backhaul downlink bandwidth availability.

If the reports indicate to the femto-cell 100 that there is at least one other femto-cell 102 with no end-to-end bandwidth limitation for the data stream then this indicates to the femto-cell 102 processor that there was no uplink bandwidth limitation in its sent data stream since that one other femto-cell was able to receive the uplinked data stream from the femto-cell without any extra delay. However, if the reports indicate to the femto-cell 100 that all of the other femto-cell have a end-to-end bandwidth limitation then this is used by the processor as an indication that none of the other femto-cells 102 were able to receive the uplinked data stream from the femto-cell without any extra delay. This indicates that there could be an uplink bandwidth limitation of the receiving femto-cell, or that all of the other femto-cells have downlink problems, which is unlikely. In other words, if each of the other femto-cells 102 responds that the packet stream rate is larger than the available bandwidth, it implies that either the femto-cell's uplink is congested or the downlinks of all the other femto-cells have become congested. When the number (e.g. four) of other femto-cells 102 is large, the latter scenario becomes much less likely to happen, and the femto-cell can assume that there are backhaul uplink limitations from the reports and adjust data transmissions to meet this limited uplink bandwidth availability. It should be noted that noted that the available bandwidth is determined by any bottleneck link between the femto-cell 100 and the other femto-cells 102. Although the ISP 104 does have other intermediate connections, it is assumed that these intermediate connections usually have sufficient bandwidth, and therefore, the femto-cell 100 uplink or the other femto-cell 102 downlinks are much more likely to be bottleneck links.

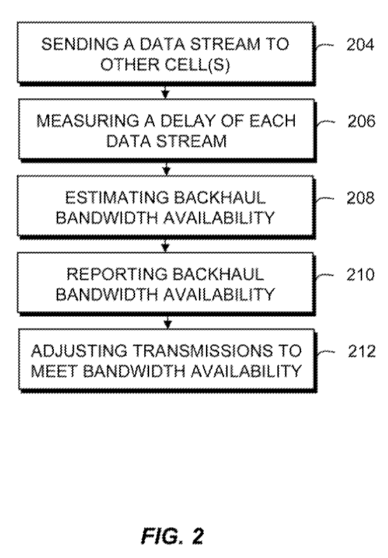

Referring now to FIG. 2, a flowchart illustrates a method for estimating an available backhaul uplink bandwidth in a femto-cell communication network, in accordance with the uplink embodiment of the present invention. The method includes a first step 204 of sending at least one defined data stream to at least one femto-cell. Every defined data stream is a stream of equally spaced packets sent at a defined rate. In particular, this step includes sending at least one defined data stream to each of at least one other femto-cell from a receiving femto-cell. The format of the data stream can be predefined in the other femto-cells so that they recognize that they should implement the functionality of the present invention using the data stream.

A next step 206 includes measuring delays of consecutive packets of the at least one defined data stream at the at least one femto-cell in the at least one other femto-cell.

A next step 208 includes estimating, from the delays of the at least one defined data stream, a backhaul bandwidth availability in the at least one other femto-cell. If the delays of the at least one data stream remain constant then it is determined that the rate of the summed data stream is smaller than the available backhaul bandwidth, and if the delays of all data streams increase then it is determined that the rate of the summed data stream is larger than the available backhaul bandwidth.

A next step 210 includes the at least one other femto-cell reporting the results from the determining step to a sending femto-cell 100 which then determines from the reports a backhaul uplink bandwidth limitation of the sending femto-cell 100. For example, if the results in the reporting step indicate that there is at least one other femto-cell with no bandwidth limitation then this indicates that there is no uplink bandwidth limitation of the sending femto-cell 100. And if the results in the reporting step indicate that all of the other femto-cells 102 have a bandwidth limitation then this is used as an indication that there is an uplink bandwidth limitation of the sending femto-cell 100, as previously described above. The sending femtocell 100 terminating data steam transmission to receiving femto cells 102 after it determines its uplink bandwidth limitation.

A next step 212 includes the femto-cell adjusting data transmissions to meet the bandwidth availability if necessary. This adjusting can include rejecting a service request if the estimated bandwidth availability cannot meet the requirement of a requesting user equipment, in either an uplink or a downlink. Alternatively, this adjusting can reduce a rate or QoS level for a requesting user. In order to know which rate or QoS level is feasible, the femto cell 100 can send data streams with predefined rates following a staircase pattern to each of the receiving femto cells 102. After determining the feasible rate according to the reports from femto cells 102, the femto cell 100 stops its transmissions.

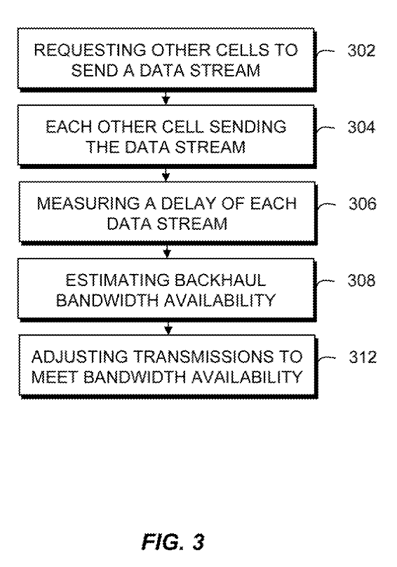

Referring now to FIG. 3, a flowchart illustrates a method for estimating an available backhaul downlink bandwidth in a femto-cell communication network, in accordance with the downlink embodiment of the present invention. The method includes a step 302 of a receiving femto-cell requesting at least one other femto-cell to send a defined data stream to the receiving femto-cell. Every defined data stream is a stream of equally spaced packets sent at a defined rate. This format of the data stream can be sent in the request or can be predefined in the other femto-cells.

A next step 304 includes sending at least one defined data stream to at least one femto-cell. Preferably, this includes sending the defined data stream from each of the at least one other femto-cell to the receiving femto-cell.

A next step 306 includes measuring delays of consecutive packets of the at least one defined data stream at the at least one (receiving) femto-cell.

A next step 308 includes estimating, from the delays of the at least one defined data stream, a backhaul bandwidth availability in the receiving femto-cell. For example, if the delays of the at least one data stream remain constant then it is determined that the rate of the summed data streams is smaller than the available backhaul bandwidth, and if the delays of every data stream increase then it is determined that the rate of the summed data streams is larger than the available backhaul bandwidth. A next step 312 includes the femto-cell adjusting data transmissions to meet the bandwidth availability if necessary.

A next step 312 includes the femto-cell adjusting data transmissions to meet the bandwidth availability if necessary. This adjusting can include rejecting a service request if the estimated bandwidth availability cannot meet the requirement of a requesting user equipment, in either an uplink or a downlink. Alternatively, this adjusting can reduce a rate or QoS level for a requesting user. In order to know which rate or QOS level is feasible, the femto cells 102 can send data streams with predefined rates following a staircase pattern to the receiving femto cell 100. After determining the feasible rate according to the measured delays from each data stream, the femto cell 100 will send acknowledgements to every femto cell 102 and terminate their transmissions.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for estimating an available backhaul bandwidth in a femto-cell communication network, the method comprising the steps of:
sending at least one defined data stream to at least one femto-cell;
measuring delays of the at least one defined data stream at the at least one femto-cell; and
estimating, from the delays of the at least one defined data stream, a backhaul bandwidth availability.

2. The method of claim 1, wherein the at least one defined data stream is a stream of equally spaced packets sent at a defined rate.

3. The method of claim 1, wherein in the estimating step, if the delays of the at least one data stream remains constant then it is determined that the rate of the summed data stream is smaller than the available backhaul bandwidth, and if the delays of every data stream increase then it is determined that the rate of the summed data stream is larger than the available backhaul bandwidth.

4. The method of claim 1, further comprising the step of a receiving femto-cell requesting at least one other femto-cell to send the defined data stream to the receiving femto-cell, and wherein the sending step includes sending the defined data stream from each of the at least one other femto-cell to the receiving femto-cell, and wherein the measuring and estimating steps are performed in the receiving femto-cell to determine a backhaul downlink bandwidth limitation of the receiving femto-cell.

5. The method of claim 1, further comprising the step of sending acknowledgements to the sending femtocells from the receiving femtocell after it determines its downlink bandwidth limitation.

6. The method of claim 1, wherein the sending step includes sending at least one defined data stream to each of at least one other femto-cell from a sending femto-cell, wherein the measuring and estimating steps are performed in the at least one other femto-cell, and further comprising a reporting step that includes the at least one other femto-cell reporting the results from the determining step to the sending femto-cell which determine from the reports a backhaul uplink bandwidth limitation.

7. The method of claim 6, wherein if the results in the reporting step indicate that there is at least one other femto-cell with no bandwidth limitation then this indicates that there is no uplink bandwidth limitation of the sending femto-cell.

8. The method of claim 6, wherein if the results in the reporting step indicate that all of the at least one other femto-cell have a bandwidth limitation then this is used as an indication that there is an uplink bandwidth limitation of the receiving femto-cell.

9. The method of claim 6, further comprising the step of the sending femtocell terminating data steam transmission to receiving femto cells after it determines its uplink bandwidth limitation.

10. The method of claim 1, further comprising the step of adjusting data transmissions to meet the bandwidth availability.

11. A femto-cell operable to estimate an available downlink backhaul bandwidth in a femto-cell communication network, the femto-cell comprising:
a transceiver operable to received a defined data stream from other femto-cells; and
a processor coupled to the transceiver, the processor operable to send a message through the transceiver requesting at least one other femto-cell to send the defined data stream to the femto-cell, whereupon the processor directs the transceiver to receive the sent defined data stream from each of the at least one other femto-cell, whereupon the processor is operable to measure delays of the at least one defined data stream, and estimate, from the delays of the at least one defined data stream, a downlink backhaul bandwidth availability.

12. The femto-cell of claim 11, wherein the at least one defined data stream is a stream of equally spaced packets sent at a defined rate.

13. The femto-cell of claim 1 1, wherein if the delays of the at least one data stream remain constant then the processor determines that the rate of the summed data stream is smaller than the available downlink backhaul bandwidth, and if the delays of every data stream increase then the processor determines that the rate of the summed data stream is larger than the available downlink backhaul bandwidth.

14. The femto-cell of claim 11, wherein the processor is further operable to adjust data transmissions to meet the downlink bandwidth availability.

15. A femto-cell operable to estimate an available uplink backhaul bandwidth in a femto-cell communication network, the femto-cell comprising:
a transceiver operable to send a defined data stream to other femto-cells and receive reports therefrom; and
a processor coupled to the transceiver, the processor operable to direct the transceiver to send the defined data stream to at least one other femto-cell, whereupon the processor is operable to receive reports from the at least other femto-cell detailing a backhaul bandwidth availability in response to a measure delays of the at least one defined data stream, and an estimate of backhaul bandwidth availability, from the delays of the at least one defined data stream.

16. The femto-cell of claim 15, wherein the at least one defined data stream is a stream of equally spaced packets sent at a defined rate.

17. The femto-cell of claim 15, wherein if the delays of the at least one data stream remain constant then the other femto-cells determine that the rate of the summed data stream is smaller than the available backhaul bandwidth, and if the delays of every data stream increase then the other femto-cells determine that the rate of the summed data stream is larger than the available backhaul bandwidth.

18. The femto-cell of claim 15, wherein if the reports indicate that there is at least one other femto-cell with no bandwidth limitation then this indicates to the processor that there is no uplink bandwidth limitation of the receiving femto-cell.

19. The femto-cell of claim 15, wherein if the reports indicate that all of the at least one other femto-cell have a bandwidth limitation then this is used by the processor as an indication that there is an uplink bandwidth limitation of the receiving femto-cell.

20. The femto-cell of claim 15, wherein the processor is further operable to determine backhaul bandwidth limitations from the reports and adjust data transmissions to meet the uplink bandwidth availability.
